(19) United States
(12) Patent Application Publication
(10) Pub. No.: US 2024/0417109 A1
(43) Pub. Date: Dec. 19, 2024

(54) ACCOUNTING FOR INERTIAL MEASUREMENT UNIT BIAS

(71) Applicant: The Boeing Company, Arlington, VA (US)

(72) Inventors: Andrew WALSH, Redondo Beach, CA (US); Reid REYNOLDS, Huntsville, AL (US)

(73) Assignee: The Boeing Company, Arlington, VA (US)

(21) Appl. No.: 18/336,333

(22) Filed: Jun. 16, 2023

(51) Int. Cl. B64G 1/28; B64G 1/24; B64G 1/26; B64G 1/36; G01P 21/02

(52) U.S. Cl. CPC B64G 1/28; B64G 1/247; B64G 1/26; B64G 1/36; G01P 21/02

(57) ABSTRACT

Techniques for accounting for rotational bias of an inertial measurement unit in a setting where momentum is conserved are presented. The techniques include: obtaining, from an inertial measurement unit, an initial magnitude of momentum and initial directional rotational rates; iteratively updating an estimate of bias of magnitude of momentum and estimates of bias of directional rotational rates based at least on the obtaining and based at least on readings from the inertial measurement unit; adjusting directional rotational rates obtained from the inertial measurement unit to account for the estimates of bias of directional rotational rates, where bias adjusted directional rotational rates are determined; and providing the bias adjusted directional rotation rates.

### GOVERNMENT SUPPORT

This invention was made with United States Government support. The government has certain rights in the invention.

### FIELD

This disclosure relates generally to inertial measurement units.

### BACKGROUND

Precise angular rotation rate estimation is important for space applications, as it is commonly integrated in the absence of additional attitude sensors (star trackers, earth sensors, etc.) to determine space vehicle orientation. However, even a small bias in the sensor (e.g., an offset between the true angular rate and the sensed angular rate) can integrate into large errors given enough time.

Angular rotation rate bias in inertial measurement units can be determined and corrected using another inertial reference, such as a star tracker, sun sensor, earth sensor, or three axis magnetometer. However, these additional sensors are either complicated or not always available, especially in a safe mode, making them unsuitable for a global solution. Further, such additional sensors are not good candidates for usage in small satellites, which may not have the size, weight, and power (SWaP) for such hardware. To further complicate things, many new satellites in the smallsat market utilize micro-electromechanical system (MEMS) technology for inertial measurement units, which is prone to large bias and/or turn-on-to-turn-on bias.

### SUMMARY

According to various embodiments, a method of accounting for rotational bias of an inertial measurement unit in a setting where momentum is conserved apre presented. The method includes: obtaining, from the inertial measurement unit, an initial magnitude of momentum and initial directional rotational rates; iteratively updating an estimate of bias of magnitude of momentum and estimates of bias of directional rotational rates based at least on the obtaining and based at least on readings from the inertial measurement unit; adjusting directional rotational rates obtained from the inertial measurement unit to account for the estimates of bias of directional rotational rates, wherein bias adjusted directional rotational rates are determined; and providing the bias adjusted directional rotation rates.

Various optional features of the above method embodiments include the following. The setting may include a micro gravity or zero gravity environment, and a vehicle in the setting may include the inertial measurement unit. The method may include changing an attitude of the vehicle based on the bias adjusted directional rotational rates. The changing may include activating a thruster of the vehicle. The estimate of bias of magnitude of momentum and the estimates of bias of directional rotational rates may be further based on outputs of an internal momentum storage device. The inertial measurement unit may include a micro electro-mechanical inertial measurement unit. The iteratively updating may include iteratively updating using a Kalman filter. The iteratively updating, the adjusting, and the providing may be performed in real time. The directional rotational rates may include three-dimensional directional rotational rates. The iteratively updating may include iteratively updating using one of: a fixed gain filter, a batch filter, recursive least squares, H-infinity control, or moving horizon estimation.

According to various embodiments, a system accounting for rotational bias of an inertial measurement unit in a setting where momentum is conserved is presented. The system includes: the inertial measurement unit; an electronic processor; and persistent non-transitory storage including instructions that, when executed by the electronic processor, configure the electronic processor to perform actions comprising: obtaining, from the inertial measurement unit, an initial magnitude of momentum and initial directional rotational rates; iteratively updating an estimate of bias of magnitude of momentum and estimates of bias of directional rotational rates based at least on the obtaining and based at least on readings from the inertial measurement unit; adjusting directional rotational rates obtained from the inertial measurement unit to account for the estimates of bias of directional rotational rates, wherein bias adjusted directional rotational rates are determined; and providing the bias adjusted directional rotation rates.

Various optional features of the above system embodiments include the following. The setting may include a micro gravity or zero gravity environment, and a vehicle in the setting may include the inertial measurement unit. The actions may further include changing an attitude of the vehicle based on the bias adjusted directional rotational rates. The changing may include activating a thruster of the vehicle. The estimate of bias of magnitude of momentum and the estimates of bias of directional rotational rates may be further based on outputs of an internal momentum storage device. The inertial measurement unit may include a micro electro-mechanical inertial measurement unit. The iteratively updating may include iteratively updating using a Kalman filter. The iteratively updating, the adjusting, and the providing may be performed in real time. The directional rotational rates may include three-dimensional directional rotational rates. The iteratively updating may include iteratively updating using one of: a fixed gain filter, a batch filter, recursive least squares, H-infinity control, or moving horizon estimation.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram of a space vehicle according to various embodiments;

FIG. 2 is a chart illustrating estimated bias in directional rotation rates of a simulated inertial measurement unit, according to various embodiments;

FIG. 3 depicts charts illustrating estimated directional rotation rates of a simulated inertial measurement unit, according to various embodiments;

FIG. 4 depicts charts illustrating errors in estimated directional rotation rates of a simulated inertial measurement unit, according to various embodiments;

FIG. 5 depicts charts illustrating errors in estimated bias in directional rotation rates, and error in estimated momentum, of a simulated inertial measurement unit, according to various embodiments;

FIG. 6 is a chart illustrating estimated bias in directional rotation rates of a simulated inertial measurement unit in the presence of non-zero momentum and imperfect inertial momentum knowledge, according to various embodiments;

FIG. 7 depicts charts illustrating estimated directional rotation rates of a simulated inertial measurement unit in the presence of non-zero momentum and imperfect inertial momentum knowledge, according to various embodiments;

FIG. 8 depicts charts illustrating errors in estimated bias in directional rotation rates, and error in estimated momentum, of a simulated inertial measurement unit in the presence of non-zero momentum and imperfect inertial momentum knowledge, according to various embodiments;

FIG. 9 is a flow chart illustrating a method of accounting for rotational bias of an inertial measurement unit according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

According to various embodiments, techniques for estimating rotational rate bias errors in an inertial measurement unit without using any additional sensors are presented. According to various embodiments, an iterative technique is used to update estimates of bias of directional rotational rates based on readings from the inertial measurement unit itself. Various embodiments may be used to determine and account for bias in low-cost, low-weight MEMS inertial measurement units. Various embodiments may determine and use bias adjusted directional rotational rates, e.g., to determine and adjust the attitude of a space vehicle.

These and other features and advantages are shown and described herein in reference to the figures.

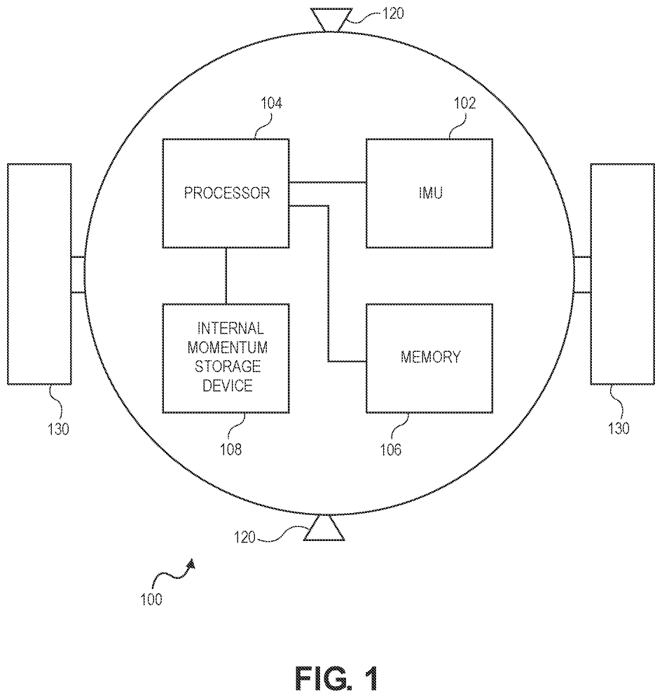

FIG. 1 is a schematic diagram of a space vehicle 100 according to various embodiments. The space vehicle 100 may be a satellite, for example. By way of non-limiting example, the space vehicle 100 as shown in FIG. 1 includes solar panels 130 to supply or supplement power, and thrusters 120, to adjust the position and/or attitude of the space vehicle 100.

The space vehicle 100 includes a processor 104, which is communicatively coupled to an inertial measurement unit 102, a memory 106, and an internal momentum storage device 108. The memory 106 may be any type of persistent and/or transient memory, which may store instructions to control the processor to perform any of the techniques disclosed herein. The inertial measurement unit 102 may be a MEMS inertial measurement unit, by way of non-limiting example. According to some embodiments, the inertial measurement unit 102 includes a gyroscope, e.g., a physical rotational gyroscope. The inertial measurement unit 102 can estimate rotational rate in three dimensions, e.g., the rate of rotation about each of an x-axis, a y-axis, and a z-axis, which may represent roll, pitch, and yaw. The internal momentum storage device 108 may include one or more flywheels, for example, which store angular inertial momentum, which may be used to adjust the attitude of the space vehicle 100.

In a system, such as the space vehicle 100, where angular momentum is conserved, e.g., in zero gravity, freefall, or micro gravity, any change in total estimated system momentum may be interpreted as bias rather than momentum. Momentum of the system may be expressed as, by way of non-limiting example, H=Jω+h, where H represents system momentum, J represents the rigid body inertia, ω represents the body rotational rates, and h represents the internal momentum. (Throughout this disclosure, symbols that are italicized may represent vectors (typically 3×1 vectors, e.g., representing rotation about an x-axis, a y-axis, and a z-axis) and symbols that are not italicized may represent matrices.)

However, although the true body rotational rates may not be directly observable, the sensed body rates from the rate sensor (e.g., inertial measurement unit) may be available. The difference between true and sensed body rates may be denoted b, and the sensed body rotational rates may be denoted as ω. Thus, the equation for a system in which momentum is conserved and where both sensed and true body rotational rates are represented may be expressed as, by way of non-limiting example, H=J(ω+b)+h.

Momentum may change in the system body frame, the frame of the rate sensor, but is fixed inertially. Rather than tracking the momentum in either the inertial frame or the body frame (which are both subject to the bias errors), the magnitude of the system momentum, which is static, may be represented as follows, by way of non-limiting example: H^{T}H=(J(ω+b)+h)^{T} (J(ω+b)+h). (In this equation, any by way of non-limiting example, the square of the momentum is represented.) An equation that relates to b and H as state variables can then be formed. To keep the math mostly linear, the equation may be solved for H^{T}H=∥H∥². The equation may be represented as, by way of non-limiting example:

$$- {ω}^{T} {J}^{T} J ω - 2 {h}^{T} J ω + {h}^{T} h = ( 2 {ω}^{T} {J}^{T} J + 2 {h}^{T} J + {b}^{T} {J}^{T} J ) b - {‖ H ‖}^{2}$$

In the above equation, the left side represents the sensor, and the right side represents the state of the observational matrix for the purpose of configuring an iterative estimator. Such an estimator provides a real time estimation of both the inertial measurement unit bias and total system momentum.

According to various embodiments, any of a variety of estimators may be used, e.g., a Kalman filter, a fixed gain filter, a batch filter, recursive least squares, H-infinity control, or moving horizon estimation. By way of non-limiting example, a Kalman filter iterative estimator is presented herein, however, any iterative estimator, not limited to those listed in the preceding, may be used according to various embodiments.

For a Kalman filter, the state vector x may be defined as the three biases concatenated with the system momentum norm squared. The bias and system momentum are static with time, so a process noise matrix Q may be incorporated to manage convergence rates. The covariance at state k given measurements up to state k−1 may be represented as, by way of non-limiting example: P_{k|k-1}=P_{k-1|k-1}+Q, where P_{k|k-1} represents the propagated covariance, P_{k-1|k-1} represents the covariance given measurements up to k−1, and Q represents the process noise matrix.

The state may be iteratively updated using the sensed body rotation rates, the inertia, and internal momentum rate for each timestep k based on the previous timestep k−1. By way of non-limiting example, the following formulation may be used for a Kalman filter iterative estimator.

The sensor measurement: zₖ=ω^{T}J^{T}Jω−2h^{T}Jω+h^{T} h

The state-to-measurement matrix: Hₖ=2ω^{T}J^{T}J+2h^{T} J+bₖ₋₁^{T}J^{T}J−1

The state vector up to time k−1:

$${x}_{k - 1} = [ \begin{matrix}{b}_{k - 1} \\ {‖ {H}_{k - 1} ‖}^{2}\end{matrix} ]$$

The predicted measurement: hₖ=Hₖxₖ₋₁

The residuals: yₖ=zₖ−hₖ

The residual covariance: Sₖ=Hₖ P_{k|k-1} Hₖ^{T}+R

The Kalman gain: Kₖ=P_{k|k-1} Hₖ^{T}Sₖ⁻¹

The state variable at time k: xₖ=xₖ₋₁+Kₖyₖ

The state co-variance matrix: P_{k|k}=(I−KₖHₖ)P_{k|k-1}

The Kalman filter iterative estimator may be executed based on the sensor measurement, the state-to-measurement matrix, the state vector up to time k−1, the predicted measurement, the residuals, the residual covariance, the Kalman gain, the state variable at time k, and the state co-variance matrix.

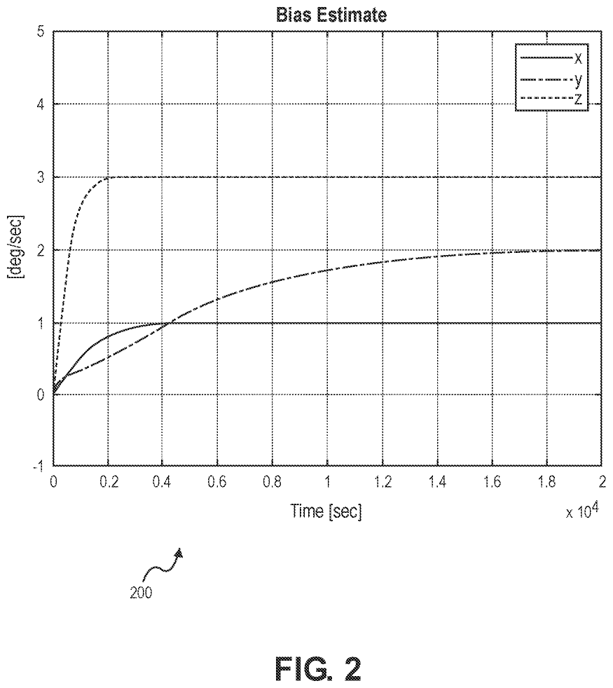

To test the performance of an example embodiment, the inventors developed a simulation, the results of which are shown and described presently in reference to FIGS. 2-8. For the simulation, a proportional rate controller was wrapped around rigid body rotational dynamics, where the controller was able to manipulate the internal momentum state of the rigid body (i.e., a reaction wheel or control moment gyroscope). There were no external torques. The only sources of error was inertial measurement unit bias and angle random walk (0.1 deg/rt-hr). A series of constant rate slews are performed (1 deg/sec for roll, pitch, and yaw).

FIG. 2 is a chart 200 illustrating estimated bias in directional rotation rates of a simulated inertial measurement unit, according to various embodiments. The x-axis in the chart 200 represents time in seconds, and the y-axis in the chart 200 represents rotational rate bias in degrees per second. All three axes of rotation (e.g., roll, pitch, and yaw) are represented in the chart 200. As is depicted in the chart 200, each bias estimate converged to a steady state value. This indicates that the rate estimates of the embodiment converge to the true values of the biases.

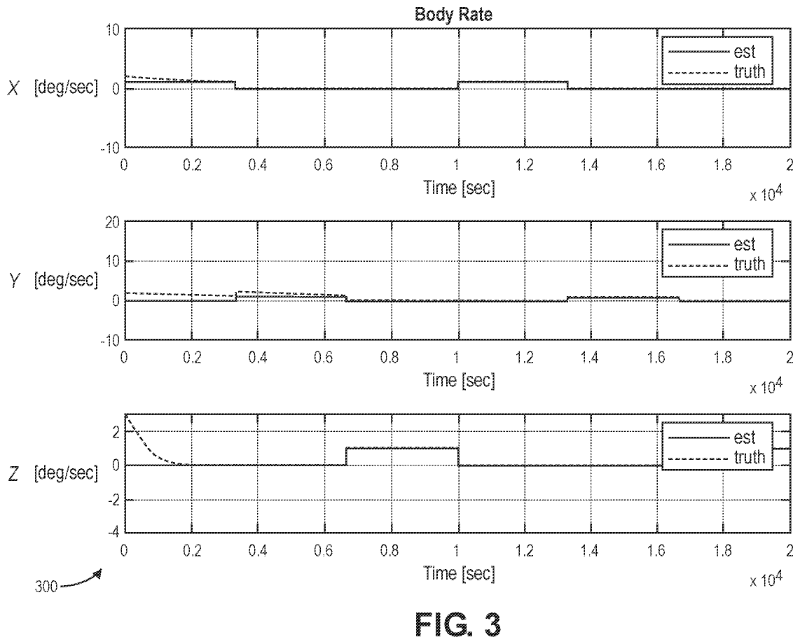

FIG. 3 depicts charts 300 illustrating estimated directional rotation rates of a simulated inertial measurement unit, according to various embodiments. The x-axes in the charts 300 represent time in seconds, and the y-axes in the charts 300 represent rotational rate in degrees per second. All three axes of rotation (e.g., roll, pitch, and yaw) are represented in the charts 300. Both the true rotational rates and the estimated rotational rates are depicted for each axis of rotation. The estimated rotational rates were obtained by adjusting the measurements from the (simulated) inertial measurement unit according to the estimated biases from the embodiment, for example, adding or subtracting each respective estimated bias from its respective measurement rate. As is seen in the charts 300, the estimated directional rotational rates closely hew to the actual (simulated) directional rotational rates.

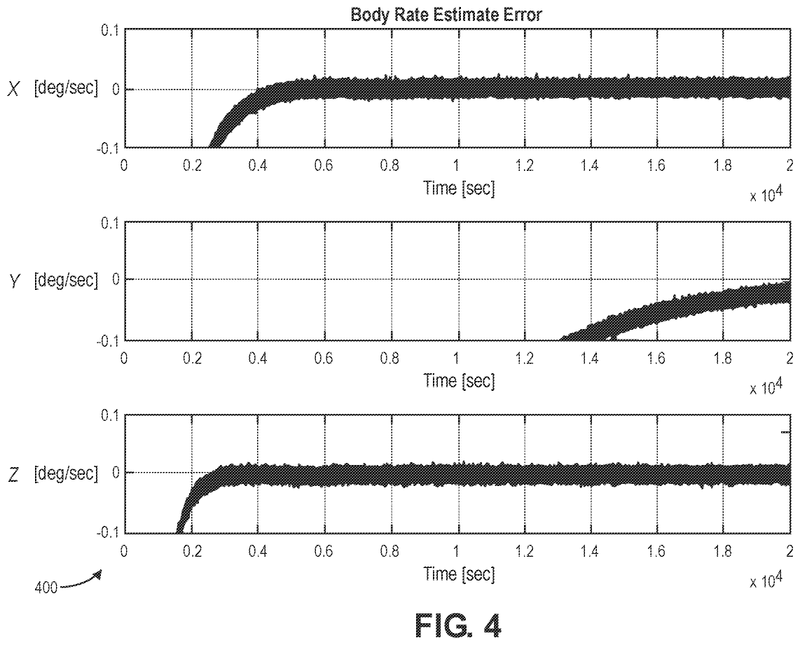

FIG. 4 depicts charts 400 illustrating errors in estimated directional rotation rates of a simulated inertial measurement unit, according to various embodiments. The x-axes in the charts 400 represent time in seconds, and the y-axes in the charts 400 represent rotational rate error in degrees per second. All three axes of rotation (e.g., roll, pitch, and yaw) are represented in the charts 400. The rotational rate errors were obtained as the difference between the estimated rotational rates and the actual (simulated) rotational rates. As is seen in the charts 400, the directional rotational rate errors all converge to zero, indicating that the boas-adjusted rotational rate estimates of the embodiments are highly accurate.

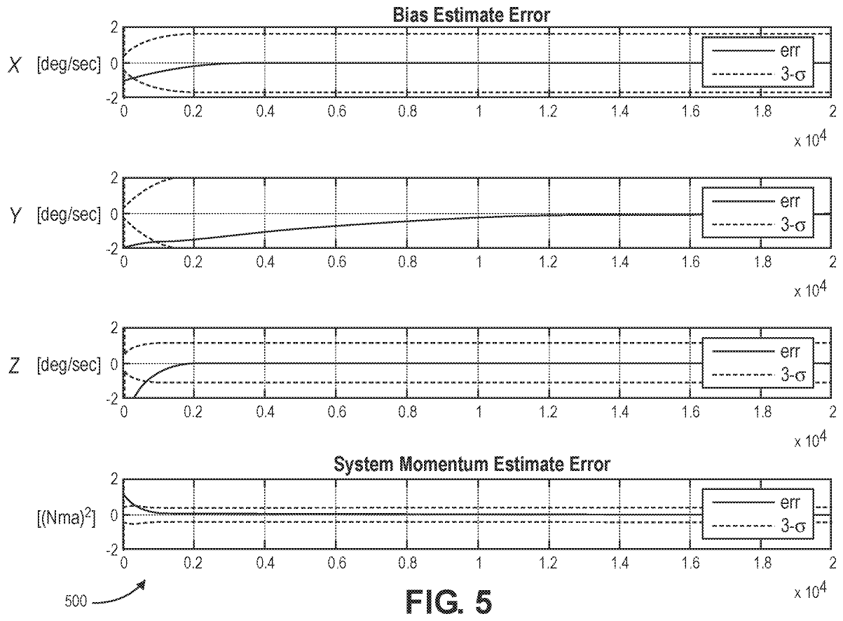

FIG. 5 depicts charts 500 illustrating errors in estimated bias in directional rotation rates, and error in estimated momentum, of a simulated inertial measurement unit, according to various embodiments. The x-axes in the charts 500 represent time in seconds, and the y-axes in the charts 500 represent rotational rate error in degrees per second. All three axes of rotation (e.g., roll, pitch, and yaw) are represented in the charts 500. Each of the charts 500 depicts error, together with curves representing three standard deviations. As seen in the charts 500, the bias error is virtually eliminated from the rate estimate, such that the remaining error is angle random walk (0.016 deg/sec 3-σ at 10 Hz). Note that the embodiment generated an estimate for total momentum, however, this may or may not be used by the system. For example, corrected estimates for directional rotation rates may be obtained without outputting the estimated total momentum. Nevertheless, as shown in FIG. 5, the Kalman filter embodiment appears well behaved, and even the system momentum estimate is accurate.

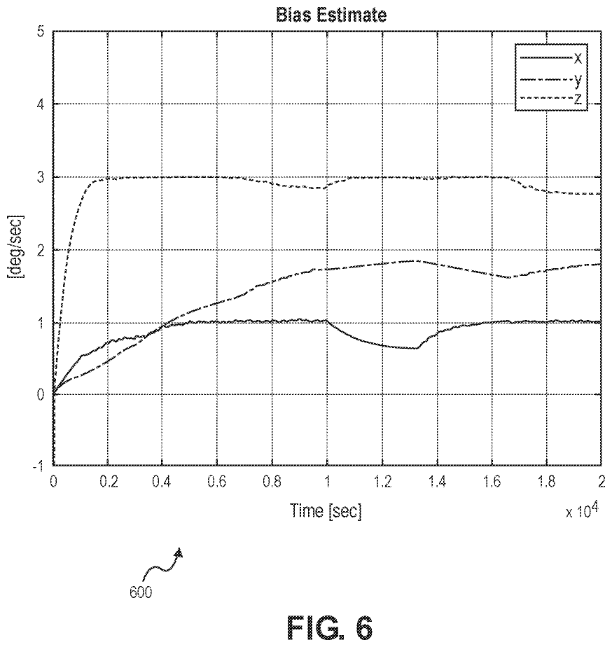

This simulation of FIGS. 2-5 assumes perfect rigid body inertia and internal momentum knowledge and zero system momentum. To assess sensitivity, a 10% error in inertia estimate was introduced, as well as 100 mNms of system momentum, for the simulation depicted in FIGS. 6-8.

FIG. 6 is a chart 600 illustrating estimated bias in directional rotation rates of a simulated inertial measurement unit in the presence of non-zero momentum and imperfect inertial momentum knowledge, according to various embodiments. The x-axis in the chart 600 represents time in seconds, and the y-axis in the chart 600 represents rotational rate bias in degrees per second. All three axes of rotation (e.g., roll, pitch, and yaw) are represented in the chart 600. As is depicted in the chart 600, each bias estimate converged to a relatively steady state value. This indicates that the rate estimates of the embodiment converge to the true values of the biases, even in the presence of non-zero momentum and imperfect internal momentum knowledge.

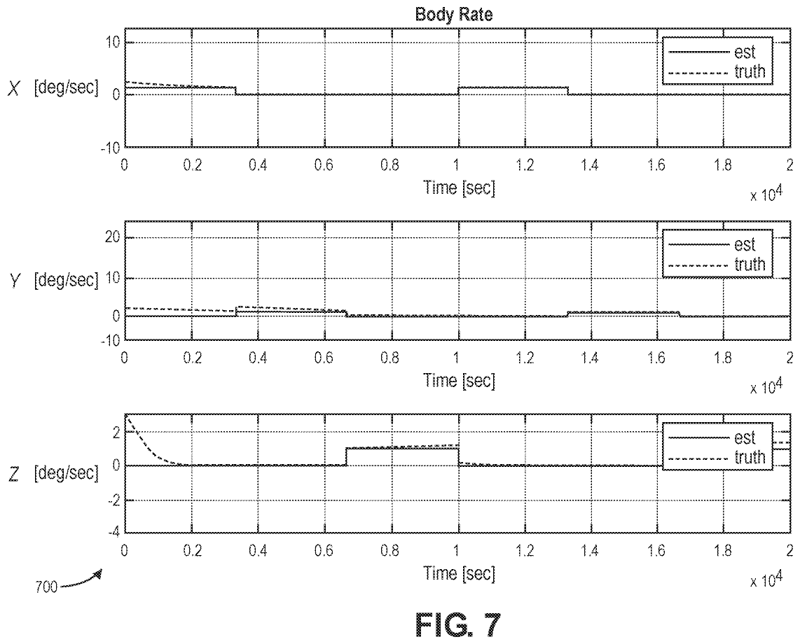

FIG. 7 depicts charts 700 illustrating estimated directional rotation rates of a simulated inertial measurement unit in the presence of non-zero momentum and imperfect inertial momentum knowledge, according to various embodiments. The x-axes in the charts 700 represent time in seconds, and the y-axes in the charts 700 represent rotational rate in degrees per second. All three axes of rotation (e.g., roll, pitch, and yaw) are represented in the charts 700. Both the true rotational rates and the estimated rotational rates are depicted for each axis of rotation. The estimated rotational rates were obtained by adjusting the measurements from the (simulated) inertial measurement unit according to the estimated biases from the embodiment, for example, adding or subtracting each respective estimated bias from its respective measurement rate. As is seen in the charts 700, the estimated directional rotational rates closely hew to the actual (simulated) directional rotational rates, even in the presence of non-zero momentum and imperfect internal momentum knowledge.

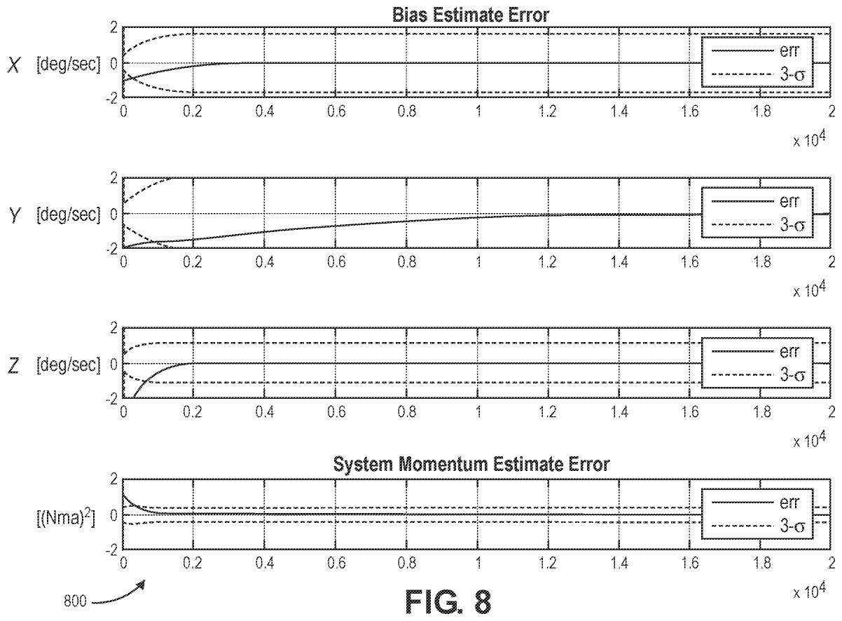

FIG. 8 depicts charts 800 illustrating errors in estimated bias in directional rotation rates, and error in estimated momentum, of a simulated inertial measurement unit in the presence of non-zero momentum and imperfect inertial momentum knowledge, according to various embodiments. The x-axes in the charts 800 represent time in seconds, and the y-axes in the charts 800 represent rotational rate error in degrees per second. All three axes of rotation (e.g., roll, pitch, and yaw) are represented in the charts 800. Each of the charts 800 depicts error, together with curves representing three standard deviations. As seen in the charts 800, the bias error is virtually eliminated from the rate estimate, such that the remaining error is angle random walk (0.016 deg/sec 3-σ at 10 Hz). As shown in FIG. 8, the Kalman filter embodiment appears well behaved, even in the presence of non-zero momentum and imperfect internal momentum knowledge.

Thus, as illustrated by FIGS. 6-8, while the errors do perturb the estimate, it appears to continue to converge across all four state estimates.

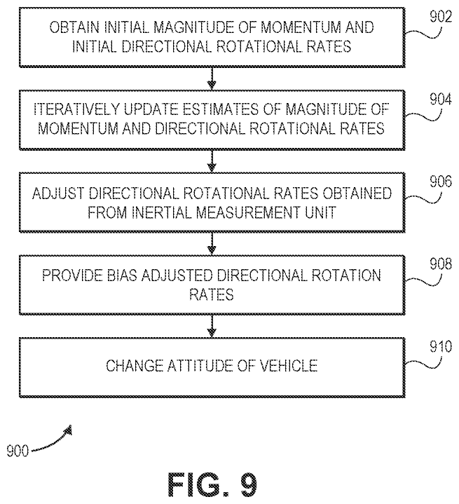

FIG. 9 is a flow chart illustrating a method 900 of accounting for rotational bias of an inertial measurement unit according to various embodiments. By way of non-limiting example, the method 900 may be implemented by a space vehicle, such as the space vehicle 100 as shown and described in reference to FIG. 1. The actions of the method 900 may be performed in real time, such that bias adjusted directional rotational rates are available for use in navigating the space vehicle, e.g., adjusting an attitude of the space vehicle.

At 902, the method 900 includes obtaining, from an inertial measurement unit, an initial magnitude of momentum and initial directional rotational rates. This action may be performed using an inertial measurement unit, such as the inertial measurement unit 102 as shown and described in reference to FIG. 1. According to some embodiments, the initial magnitude of momentum is further based on an output from an internal momentum storage device, such as the internal momentum storage device 108 as shown and described herein in reference to FIG. 1. The initial directional rotational rates may include rotational rates about each of three axes, e.g., and x-axis, an y-axis, and a z-axis. The initial momentum may be an initial total momentum. The method 900 may include obtaining an initial estimate of momentum magnitude and inertial measurement unit rotational bias.

At 904, the method 900 includes iteratively updating an estimate of bias of magnitude of momentum and estimates of bias of directional rotational rates based at least on the actions of 902 and based on readings from the inertial measurement unit. This action may be performed using an iterative estimator, such as, by way of non-limiting example, a Kalman filter, a fixed gain filter, a batch filter, a recursive least squares technique, an H-infinity control, or a moving horizon estimator. The iteration may be performed throughout a time interval of operation of a space vehicle. A basis for the iteration may use the results from the actions of 902. The iteration may be updated using the readings from the inertial measurement unit, which may be obtained at each step of the iteration. According to some embodiments, the iteration may be updated also using outputs of an internal momentum storage device, such as the internal momentum storage device 108 as shown and described herein in reference to FIG. 1. Such outputs may be obtained at each step of the iteration.

According to some embodiments, the actions of 902 include: first, computing momentum magnitude based on a raw inertial measurement unit sensor reading, an inertial measurement unit bias estimate, and an internal momentum storage device reading, second, computing a residual between predicted momentum and measured momentum, and third, updating the inertial measurement unit bias estimate and the momentum magnitude based on the residual.

At 906, the method 900 includes adjusting directional rotational rates obtained from the inertial measurement unit to account for the estimates of bias of directional rotational rates, wherein bias adjusted directional rotational rates are determined. The actions of 906 may be performed by adding or subtracting the estimated biases from the respective directional rotational rates read from the inertial measurement unit. For example, if the bias is positive, e.g., an inertial measurement unit reading is inaccurate in that it is greater than the true rotational rate, then the bias may be subtracted from the inertial measurement unit reading to obtain the bias adjusted directional rotational rate. Conversely, if the bias is negative, e.g., the inertial measurement unit reading is inaccurate in that it is less than the true rotational rate, then the bias may be added to the inertial measurement unit reading to obtain the bias adjusted directional rotational rate.

At 908, the method 900 includes providing the bias adjusted directional rotation rates. According to various embodiments, the bias adjusted directional rotational rates may be provided to a different system in the space vehicle, e.g., a navigation system, such as an attitude control system. In general, the bias adjusted directional rotational rates may be provided by outputting them from a processor, such as the processor 104 as shown and described in reference to FIG. 1.

At 910, the method 900 includes changing the attitude of the space vehicle. For example, this action may be based on integrating one or more of the bias adjusted directional rotational rates. The action may include operation of an internal momentum storage device, such as the internal momentum storage device 108 as shown and described in reference to FIG. 1. The action may include operation of one or more thrusters, such as the thrusters 120 as shown and described in reference to FIG. 1.

Thus, the method 900 determines and applies rotational bias corrections to raw inertial measurement unit sensor readings for external use (e.g., spacecraft control, etc.).

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method of accounting for rotational bias of an inertial measurement unit in a setting where momentum is conserved, the method comprising:
obtaining, from the inertial measurement unit, an initial magnitude of momentum and initial directional rotational rates;
iteratively updating an estimate of bias of magnitude of momentum and estimates of bias of directional rotational rates based at least on the obtaining and based at least on readings from the inertial measurement unit;
adjusting directional rotational rates obtained from the inertial measurement unit to account for the estimates of bias of directional rotational rates, wherein bias adjusted directional rotational rates are determined; and
providing the bias adjusted directional rotation rates.

2. The method of claim 1, wherein the setting comprises a micro gravity or zero gravity environment, and wherein a vehicle in the setting comprises the inertial measurement unit.

3. The method of claim 2, further comprising changing an attitude of the vehicle based on the bias adjusted directional rotational rates.

4. The method of claim 3, wherein the changing comprises activating a thruster of the vehicle.

5. The method of claim 1, wherein the estimate of bias of magnitude of momentum and the estimates of bias of directional rotational rates are further based on outputs of an internal momentum storage device.

6. The method of claim 1, wherein the inertial measurement unit comprises a micro electro-mechanical inertial measurement unit.

7. The method of claim 1, wherein the iteratively updating comprises iteratively updating using a Kalman filter.

8. The method of claim 1, wherein the iteratively updating, the adjusting, and the providing are performed in real time.

9. The method of claim 1, wherein the directional rotational rates comprise three-dimensional directional rotational rates.

10. The method of claim 1, wherein the iteratively updating comprises iteratively updating using one of: a fixed gain filter, a batch filter, recursive least squares, H-infinity control, or moving horizon estimation.

11. A system accounting for rotational bias of an inertial measurement unit in a setting where momentum is conserved, the system comprising:
the inertial measurement unit;
an electronic processor; and
persistent non-transitory storage including instructions that, when executed by the electronic processor, configure the electronic processor to perform actions comprising:
obtaining, from the inertial measurement unit, an initial magnitude of momentum and initial directional rotational rates;
iteratively updating an estimate of bias of magnitude of momentum and estimates of bias of directional rotational rates based at least on the obtaining and based at least on readings from the inertial measurement unit;
adjusting directional rotational rates obtained from the inertial measurement unit to account for the estimates of bias of directional rotational rates, wherein bias adjusted directional rotational rates are determined; and
providing the bias adjusted directional rotation rates.

12. The system of claim 11, wherein the setting comprises a micro gravity or zero gravity environment, and wherein a vehicle in the setting comprises the inertial measurement unit.

13. The system of claim 12, wherein the actions further comprise changing an attitude of the vehicle based on the bias adjusted directional rotational rates.

14. The system of claim 13, wherein the changing comprises activating a thruster of the vehicle.

15. The system of claim 11, wherein the estimate of bias of magnitude of momentum and the estimates of bias of directional rotational rates are further based on outputs of an internal momentum storage device.

16. The system of claim 11, wherein the inertial measurement unit comprises a micro electro-mechanical inertial measurement unit.

17. The system of claim 11, wherein the iteratively updating comprises iteratively updating using a Kalman filter.

18. The system of claim 11, wherein the iteratively updating, the adjusting, and the providing are performed in real time.

19. The system of claim 11, wherein the directional rotational rates comprise three-dimensional directional rotational rates.

20. The system of claim 11, wherein the iteratively updating comprises iteratively updating using one of: a fixed gain filter, a batch filter, recursive least squares, H-infinity control, or moving horizon estimation.
